(19) United States
(12) Patent Application Publication
(10) Pub. No.: US 2010/0187723 A1
(43) Pub. Date: Jul. 29, 2010

(54) METHOD FOR PRODUCING MULTILAYER MOLDED ARTICLE

(75) Inventors: Taro Miyazawa, Ichihara-shi (JP); Kenichi Higashi, Ichihara-shi (JP)

Correspondence Address: FITCH, EVEN, TABIN & FLANNERY, P. O. BOX 18415, WASHINGTON, DC, 20036, US

(73) Assignee: SUMITOMO CHEMICAL COMPANY, LIMITED, Tokyo (JP)

(21) Appl. No.: 12/694,961

(22) Filed: Jan. 27, 2010

(30) Foreign Application Priority Data
Jan. 29, 2009 (JP) 2009-018473

(51) Int. Cl. B29C 45/16

(52) U.S. Cl. 264/259

(57) ABSTRACT

A method for producing a multilayer molded article is proposed, whereby a thin cover layer can be formed widely on a substrate layer. The method has a first step of placing a substrate in a cavity formed between a pair of mold halves, and a second step of supplying a second thermoplastic resin material being in a molten state, at an injection rate of 200 cm³/sec or more to a clearance formed between the substrate and a cavity surface facing the substrate, wherein in the second step, the clamping force of the pair of mold halves is set so that the cavity volume will increase due to pressure increase in the cavity accompanying the supply of the second thermoplastic resin material. The method is useful for producing large-sized plastic components with excellent appearance quality.

### RELATED APPLICATIONS

This application claims the foreign priority benefit from Japanese Application 2009-018473, filed Jan. 29, 2009, the complete disclosure of which is incorporated herein by reference.

### BACKGROUND OF THE INVENTION

1. Field of the Invention

The present invention relates to a method for the production of a multilayer molded article having a substrate layer of a first thermoplastic resin material and a cover layer of a second thermoplastic resin material disposed on the substrate layer.

2. Description of the Related Art

Thermoplastic resin molded articles produced by injection molding or compression molding are used in various fields because they are good in economical efficiency, lightweight property, shapability, and so on. Such thermoplastic resin molded articles are also used as parts of expensive industrial products and they are required to have higher qualities in these applications. For example, thermoplastic resin molded articles to be used for automotive exterior components or the like are required to have a high appearance quality, such as having no appearance defects like surface distortion, unevenness in gloss, and weld lines in the surface, in addition to qualities relating to a mechanical property, such as impact resistance and rigidity.

The mechanical properties and the appearance quality of a thermoplastic resin molded article are often in a trade-off relationship and a technology to improve both the properties at a good balance has been awaited. JP 8-90593 A, JP 2001-225348 A, and JP 2005-132016 A are related to a multilayer molded article having a substrate layer and a cover layer disposed on the substrate layer. These documents disclose techniques of using different materials as resin materials for forming a substrate layer and a cover layer.

On the other hand, JP 4-138233 A listed below discloses an invention which is intended to solve a problem of efficiently obtaining a molded article that has good appearance and that deforms only a little. This document discloses a technology to supply a molten resin into a cavity while opening a mold at a prescribed speed during a process of producing a molded article of a thermoplastic resin.

Recently, a higher appearance quality has increasingly been required while maintaining excellent mechanical properties. However, it has been difficult for the conventional technologies disclosed in JP 8-90593 A, JP 2001-225348 A, and JP 2005-132016 A to fully, reliably meet such a requirement. In particular, when producing a comparatively large component, it was difficult to cover its surface widely with a thin cover layer having an excellent appearance quality. Moreover, it is necessary for conventional techniques to make a cover layer comparatively thick and therefore appearance defects, such as surface distortion, weld lines, and unevenness in gloss, easily occur. In addition, the method disclosed in JP 4-138233 A is one to be used for producing a molded article made of a single resin composition and there is a room for improvement in order to apply it to the production of a multilayer molded article.

### SUMMARY OF THE INVENTION

The object thereof is to provide a method for producing a multilayer molded article, the method being capable of forming a thin cover layer widely on a substrate layer and being useful for producing a large-sized plastic component with an excellent appearance quality.

The present invention is directed to a method for the production of a multilayer molded article comprising a substrate layer of a first thermoplastic resin material and a cover layer of a second thermoplastic resin material disposed on the substrate layer, the method comprising a first step of placing a substrate in a cavity formed between a pair of mold halves, and a second step of supplying the second thermoplastic resin material being in a molten state, at an injection rate of 200 cm³/sec or more to a space formed between the substrate and a cavity surface of a mold half facing the substrate, wherein in the second step, the clamping force of the pair of mold halves is set so that the cavity volume will increase due to pressure increase in the cavity accompanying the supply of the second thermoplastic resin material. The injection rate referred to herein means the injection volume per second.

According to the present invention, it is possible to form a thin cover layer on a substrate layer over a wide range and it becomes possible to produce a large plastic component with a good appearance quality.

### BRIEF DESCRIPTION OF THE DRAWINGS

FIG. 1 is a schematic sectional diagram depicting an example of a multilayer molded article produced by the method of the present invention.

FIG. 2 is a schematic sectional diagram depicting an example of a mold to be used for the method of the present invention. The mold includes a pair of mold halves. One of the mold halves is a stationary half including a top clamping plate 20, a cavity retainer plate 21, guide pins 22, a runner stopper plate 23, and a sprue bush 25. The other one is a movable half including a bottom clamping plate 30, a core retainer plate 31, spacer blocks 32, a supporting plate 33, ejector pins 35, and ejector plates 36.

FIG. 3 is a schematic sectional diagram depicting a state wherein a mold has been closed.

FIG. 4 is a schematic sectional diagram depicting a state wherein a substrate has been placed in a cavity of a mold.

FIG. 5 is a schematic sectional diagram depicting a mold in a state wherein a mold has been opened and a multilayer molded article taken out from the mold.

FIG. 6 is a schematic sectional diagram depicting another example of a mold to be used for the method of the present invention.

### DETAILED DESCRIPTION OF THE PREFERRED EMBODIMENTS

Embodiments of the present invention are described below with reference to the accompanying drawings.

### <Multilayer Molded Article>

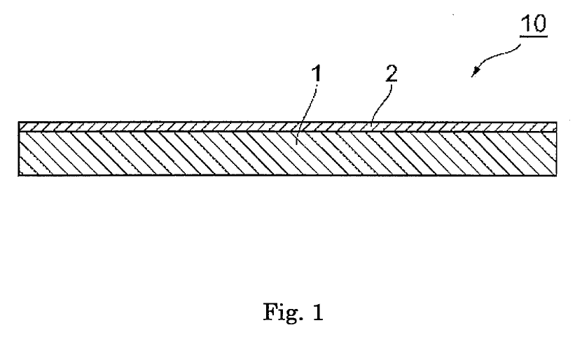

The multilayer molded article 10 shown in FIG. 1 has a layer of a substrate 1 formed in a tabular shape and a cover layer 2 disposed so that it may cover one face of the layer of the substrate 1. The layer of the substrate 1 and the cover layer 2 are each made of a thermoplastic resin material. A layer of a substrate may herein be referred to a substrate layer.

The substrate layer 1 constitutes the main body of the multilayer molded article 10 and is high in impact resistance and rigidity in order to secure good mechanical properties. The thermoplastic resin that is a primary component of the thermoplastic resin material constituting the substrate layer 1 (i.e., the first thermoplastic resin material) may be chosen appropriately depending upon the mechanical properties the multilayer molded article 10 is required to have and the kind thereof is not particularly restricted. Specific examples of the thermoplastic resin include olefin-based resins, styrene-based resins, acrylic resins, amide-based resins, thermoplastic ester-based resins, polycarbonate, and thermoplastic elastomers. Such resins may be used singly, or two or more of such resins may be used in combination. Among these thermoplastic resins, an olefin-based resin or a mixture of an olefin-based resin and a thermoplastic elastomer is preferably used.

An olefin-based resin is a resin that contains repeating units derived from an olefin in an amount of 50% by mass or more, and examples thereof include homopolymers of α-olefins having 20 or less carbon atoms, such as ethylene, propylene, butene-1, pentene-1, hexene-1, 3-methylbutene-1, and 4-methylpentene-1, copolymers obtained by copolymerizing at least two kinds of monomers selected from such α-olefins, and copolymers of such α-olefins and unsaturated monomers copolymerizable with the α-olefins.

Examples of the unsaturated monomers include unsaturated carboxylic acids, such as acrylic acid and methacrylic acid; alkyl ester derivatives of unsaturated carboxylic acids, such as methyl (meth)acrylate, 2-ethylhexyl acrylate, ethyl (meth)acrylate, and butyl (meth)acrylate; unsaturated dicarboxylic acids or acid anhydrides, such as fumaric acid, maleic acid, maleic anhydride, and itaconic acid; derivatives of unsaturated carboxylic acids or unsaturated dicarboxylic acids, such as acrylamide, N-(hydroxymethyl)acrylamide, glycidyl (meth)acrylate, acrylonitrile, methacrylonitrile, mono or diethyl esters of maleic acid, N-phenylmaleimide, and N,N′-meta-phenylene bismaleimide.

It is preferable to use a propylene-based resin as the olefin-based resin. Examples of the propylene-based resin include propylene homopolymers, and copolymers of propylene and at least one member selected from the group consisting of ethylene and α-olefins having 4 to 12 carbon atoms. Each of such homopolymers or copolymers may be used solely or two or more of them may be used in combination. Examples of the α-olefins having from 4 to 12 carbon atoms include 1-butene, 4-methyl-1-pentene, 1-hexene, and 1-octene.

When using a copolymer of propylene and at least one member selected from the group consisting of ethylene and α-olefins having 4 to 12 carbon atoms, it is desirable to use a copolymer containing repeating units derived from propylene in an amount of at least 50 parts by mass per 100 parts by mass of the copolymer. When the copolymer contains repeating units derived from two or more kinds of monomers in addition to propylene units, it is desirable that the total amount of the repeating units derived from the monomers other than propylene be 35 parts by mass or less. The softness and the impact resistance of a copolymer can be controlled by controlling the amounts of the repeating units derived from ethylene or α-olefins having 4 to 12 carbon atoms in the copolymer. When the propylene-based resin is a copolymer, the copolymer may be either a random copolymer or a block copolymer.

As to the olefin-based resin, it is also desirable to use a mixture of a copolymer of the above-mentioned propylene-based resin and an ethylene-α-olefin copolymer. The ethylene-α-olefin copolymer is a copolymer of ethylene and an α-olefin having 4 to 12 carbon atoms, and examples thereof include copolymers of ethylene and butene-1, hexene-1, octene-1, decene-1, or the like. Examples of preferable ethylene-α-olefin copolymers include an ethylene-butene-1 copolymer rubber (EBR), an ethylene-hexene copolymer rubber (EHR), and an ethylene-octene copolymer rubber (EOR).

The content of the repeating units derived from ethylene in an ethylene-α-olefin copolymer is 50 to 90% by mass, and preferably 60 to 90% by mass. The content of the repeating units derived from ethylene in an ethylene-α-olefin copolymer can be measured by a ¹³C-NMR method. The density of a copolymer of ethylene and an α-olefin is usually 0.85 to 0.89 g/cm³, and preferably 0.86 to 0.88 g/cm³. The density is a value measured in accordance with JIS K7112.

Furthermore, a mixture resulting from addition of a vinyl aromatic compound-containing elastomer to the aforementioned olefin-based resin may be used as the thermoplastic resin. Examples of the vinyl aromatic compound-containing elastomer include such block copolymers as styrene-ethylene-butene-styrene rubbers (SEBS), styrene-ethylene-propylene-styrene rubbers (SEPS), styrene-butadiene rubbers (SBR), styrene-butadiene-styrene rubbers (SBS), and styrene-isoprene-styrene rubbers (SIS), and block copolymers produced by hydrogenating such rubber components.

Moreover, rubbers to be obtained by making a vinyl aromatic compound, such as styrene, react with an olefin-based rubber, such as ethylene-propylene-conjugated diene-based rubbers (EPDM), can also be used suitably. Two or more vinyl aromatic compound-containing elastomers may be used in combination. A vinyl aromatic compound-containing elastomer is an elastomer obtained by carrying out polymerization by using a vinyl aromatic compound as a monomer, and examples thereof include a block copolymer composed of a vinyl aromatic compound polymer block and a conjugated diene-base polymer block, and a block copolymer resulting from hydrogenating double bonds of the conjugated diene moieties of the foregoing block copolymer. It is desirable that 80% or more of the double bonds of the conjugated diene moieties of the block copolymer have been hydrogenated. When the amount of the vinyl aromatic compound-containing elastomer is 100% by mass, it is desirable that the content of the repeating units derived from a vinyl aromatic compound monomer be 10 to 20% by mass.

The substrate layer 1 may contain a filler. Examples of the filler include talc, mica, clay, calcium carbonate, aluminum hydroxide, magnesium hydroxide, wollastonite, barium sulfate, glass fiber, carbon fiber, silica, calcium silicate, potassium titanate, metal fiber and organic fiber coated with metal. Each of these fillers may be used solely or two or more of them may be used in combination.

The cover layer 2 has been formed so that it would cover the surface of the substrate layer 1 in order to primarily attain an excellent appearance quality of the multilayer molded article 10. The thickness of the cover layer 2 is preferably 0.6 mm or less, more preferably 0.5 mm or less, and even more preferably 0.4 mm or less. By adjusting the thickness of the cover layer 2 to 0.6 mm or less, it is possible to better control defects in the appearance of the cover layer 2, such as unevenness in gloss, in comparison to cases where the thickness exceeds 0.6 mm. In addition, it is possible to reduce the amount of the resin material needed for forming the cover layer 2 and, therefore, it is possible to lower the production cost. On the other hand, the thickness of the cover layer 2 is preferably 0.01 mm or more, and more preferably 0.05 mm or more. By adjusting the thickness of the cover layer 2 to 0.01 mm or more, it becomes possible to produce a multilayer molded article 10 better in appearance quality in comparison to cases where the thickness is less than 0.01 mm.

Although a resin the same as the thermoplastic resin to be used for the substrate layer 1 may be used as the thermoplastic resin that is a primary component of the thermoplastic resin material for constituting the cover layer 2 (i.e., the second thermoplastic resin material), it is preferable to use a crystalline polyolefin-based resin. The crystalline polyolefin-based resin can easily form a cover layer that is better in mechanical properties and thinner in comparison to non-crystalline resins. Therefore, even if the thickness of the cover layer 2 is made as thin as 0.6 mm or less, good mechanical properties of the cover layer 2 can be attained.

The term “crystalline polyolefin-based resin” referred to herein means a polyolefin-based resin that has a crystal melting peak with an amount of heat of crystals of greater than 1 J/g or a crystallization peak with an amount of crystallization heat of greater than 1 J/g measured within a range of from −100° C. to 300° C. by differential scanning calorimetry carried out in accordance with JIS K7122. A crystalline polypropylene-based resin is particularly suitable as the crystalline polyolefin-based resin from the viewpoint of the rigidity and impact resistance of a molded article.

The melt flow rate (MFR) of the crystalline polyolefin-based resin contained in the cover layer 2 is preferably 5 to 400 g/10 minutes, and more preferably 10 to 200 g/10 minutes. When the MFR is 5 g/10 minutes or more, pressure increase that occurs during the filling of resin can be reduced more in comparison with cases where the MFR is less than 5 g/10 minutes. On the other hand, when the MFR is 400 g/10 minutes or less, a cover layer 2 higher in impact strength can be formed in comparison with cases where the MFR is greater than 400 g/10 minutes. The melt flow rate (MFR) referred to herein means a value measured at a temperature of 230° C. in accordance with JIS K6758.

The cover layer 2 may contain a filler. Examples of the filler include talc, mica, clay, calcium carbonate, aluminum hydroxide, magnesium hydroxide, wollastonite, barium sulfate, glass fiber, carbon fiber, silica, calcium silicate, potassium titanate, metal fiber and organic fiber coated with metal. Each of these fillers may be used solely or two or more of them may be used in combination. The content of the filler is preferably 5 to 50 parts by mass, and more preferably 10 to 40 parts by mass per 100 parts by mass of the second thermoplastic resin material. By adjusting the content of the filler to 5 parts by mass or more, it becomes possible to improve the mechanical properties or appearance quality of the cover layer 2. On the other hand, by adjusting the content of the filler to 50 parts by mass or less, it is possible to sufficiently control faults, such as delamination of the cover layer 2 or formation of a weld line in the surface of the multilayer molded article 10.

The thermoplastic resin materials that constitute the substrate layer 1 and the cover layer 2, respectively, may further contain an antioxidant, a heat stabilizer, a UV absorber, an antistatic agent, a dispersing agent, a chlorine supplier, a lubricant, a decomposer, a metal deactivator, a flame retarder, an organic pigment, an inorganic pigment, an organic filler, an inorganic antimicrobial agent, an organic antibacterial agent, a nucleating agent, and so on.

### Mold

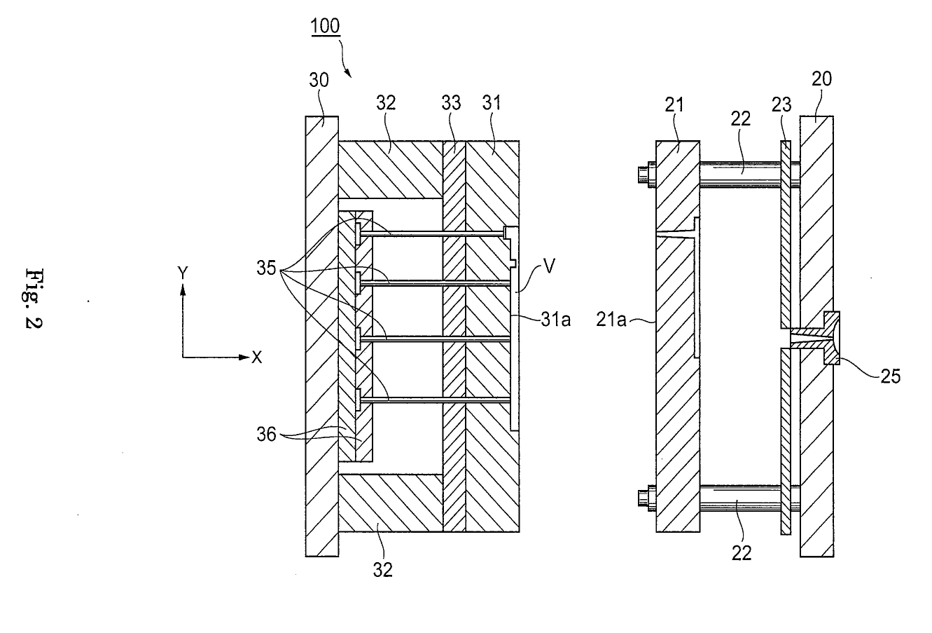

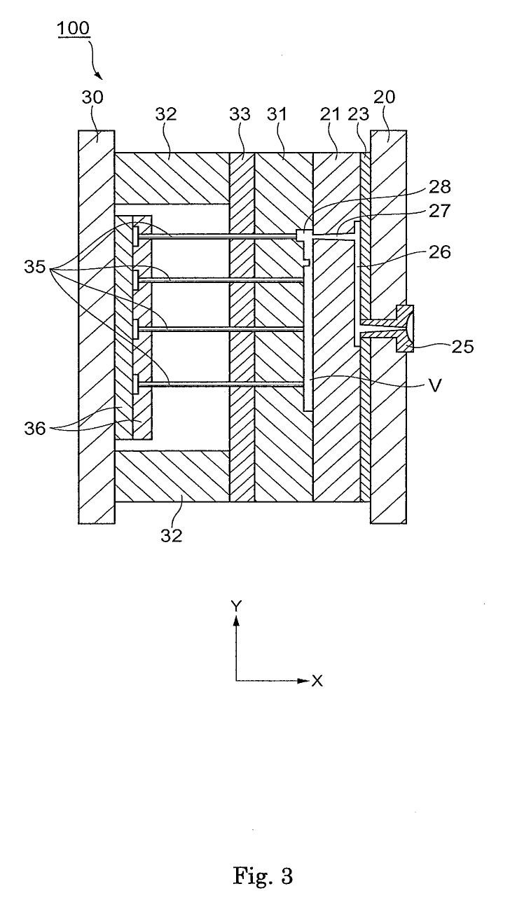

One example of the mold to be used for the production of a multilayer molded article is described with reference to FIGS. 2 and 3. A mold 100 is used for forming a cover layer 2 on the surface of a substrate layer 1 depicted in FIG. 1 to produce the multilayer molded article 10. The mold 100 has a top clamping plate 20 and a bottom clamping plate 30 which are arranged so that they may face each other. The top clamping plate 20 has been fixed on the side of the injection side which injects a resin material in a molten state. The bottom clamping plate 30 can reciprocate in the X-axial direction shown in FIGS. 2 and 3 by the action of a mold opening/closing mechanism, not shown.

A cavity retainer plate 21 and a core retainer plate 31 are arranged at between the top clamping plate 20 and the bottom clamping plate 30 so that the plates 21 and 31 face each other. The cavity retainer plate 21 has been configured so that it can move in the X-axial direction and it is guided by four guide pins 22 which project from the inner surface of the top clamping plate 20. The core retainer 31 has been fixed to the bottom clamping plate 30 with a spacer block 32 and a supporting plate 33 located therebetween, and the core retainer plate 31 reciprocates in the X-axial direction following the movement of the bottom clamping plate 30.

The cavity retainer plate 21 and the core retainer plate 31 go back and forth between a open state where the cavity retainer plate 21 and the core retainer plate 31 are separated (see FIG. 2) and a closed state where the cavity retainer plate 21 and the core retainer plate 31 are in contact (see FIG. 3) following the reciprocative movement of the bottom clamping plate 30. The cavity retainer plate 21 and the core retainer plate 31 form inside a cavity V having a rectangular plate-like shape in the closed state. A cavity surface is formed of a surface 21a of the cavity retainer plate 21 and a surface 31a of the core retainer plate 31. In this embodiment, a substrate 1 is placed so that it may come into contact with the surface 31a of the core retainer plate 31, so that a clearance C will be formed between the substrate 1 and the surface 21a of the cavity retainer plate 21 as described later.

The mold 100 is configured so that the clamping force can be determined freely within a prescribed range. Because of such a configuration, the increase in pressure in the cavity V accompanying injection of a resin material can be controlled. Namely, the mold 100 has been configured so that, for example, the clamping force can be set comparatively low before injecting a resin material or so that only the own weight of the bottom clamping plate 30, the core retainer plate 31, and so on may work. Thereby, when the pressure in the cavity V exceeds a prescribed value, the bottom clamping plate 30 is pushed by the pressure to move, so that the cavity volume can be increased.

The cavity surface is preferably formed of a material having a heat conductivity of 0.05 to 10 W/m·K. When the cavity surface is formed of a material having a heat conductivity of 0.05 to 10 W/m·K, it is possible to prevent rapid change in temperature in the cavity V even if a molten resin is injected at a high rate and therefore it is easy to keep the inside of the cavity V at a desired temperature. As a result, it is possible to produce multilayer molded articles having an excellent appearance quality at a sufficiently high yield. Examples of a material having such a low heat conductivity include polyimides, polytetrafluoroethylene, phenol-based resins, and ceramics, such as zirconia ceramic. The heat conductivity of the material that forms the cavity surface is more preferably 0.05 to 9 W/m·K, and even more preferably 0.05 to 8.5 W/m·K. In this embodiment, it is desirable that at least the surface 21a of the cavity retainer plate 21 be formed of a material having a heat conductivity within the above-mentioned range.

At the center of the top clamping plate 20 is disposed an approximately funnel-like sprue bush 25 into which the tip of a nozzle of an injection unit, not shown, is to be inserted. A runner stopper plate 23 penetrated by the guide pins 22 has been disposed between the top clamping plate 20 and the cavity retainer plate 21, and the runner stopper plate 23 and the cavity retainer plate 21 have formed a runner molding portion 26 that forms a passage through which a resin material in a molten state will flow (see FIG. 3). The runner molding portion 26 is connected to the exit side of the sprue bush 25, and extends along the Y-axis direction about its joint to the sprue bush 25.

In the cavity retainer plate 21 has been formed a sprue molding portion 27 that penetrates the cavity retainer plate 21 along the X-axial direction. This sprue molding portion 27 has been formed near the tip of the runner molding portion 26 in the Y-axis direction. Between the cavity retainer plate 21 and the core retainer plate 31 has been formed a gate portion 28 that constitutes an inlet port of the cavity V. The gate portion 28 and the runner molding portion 26 are interconnected through the sprue molding portion 27.

A supporting plate 33 has been fixed to a surface of the core retainer plate 31 on the side opposite to the cavity V. Between the supporting plate 33 and the bottom clamping plate 30 has been disposed an ejector plate 36 that holds four ejector pins 35 for removing a multilayer molded article 10 formed in the cavity V. Between the supporting plate 33 and the bottom clamping plate 30, spacer blocks 32 have been disposed on the both sides of the ejector plate 36 that moves in the X-axis direction.

In this embodiment, an injection unit equipped with an in-line type screw can be used, for example. The injection unit has a barrel, a screw that can rotate in the barrel and can move forward and backward in its shaft direction, a hopper through which a resin material is fed into the barrel, and a motor which controls the advance, the retreat, and the rotation of the screw.

### Method for Producing a Multilayer Molded Article

For the production of a multilayer molded article 10, a substrate 1 processed into a prescribed shape is prepared first. The method for shaping the substrate 1 is not particularly restricted, and the substrate 1 may be produced by injection molding, compression molding, or the like.

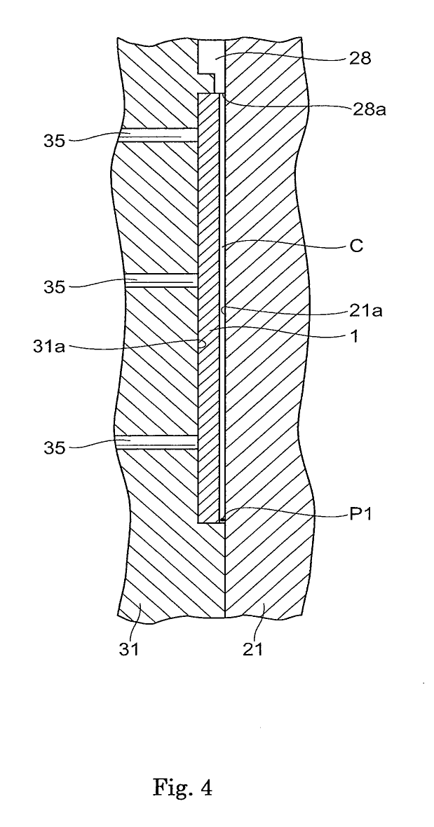

As illustrated in FIG. 4, the substrate 1 is placed in the cavity V so that the surface 31a of the core retainer plate 31 and a first face of the substrate 1 may come into contact with each other (a first step). Thereby, a clearance C is formed between a second face of the substrate 1 and the surface 21a of the cavity retainer plate 21, the surface facing the second face of the substrate. A cover layer 2 is formed by filling up the clearance C with a thermoplastic resin material. The thickness of the cover layer 2 can be made 0.6 mm or less by setting the width of the clearance C to 0.6 mm or less. Determining the clearance C as described above makes it possible to prevent the cover layer 2 from coming to have a thickness greater than a desired thickness, to make the resin material for forming the cover layer 2 flow smoothly, and to prevent the occurrence of surface defects, such as unevenness in gloss. Although an example in which one face of the substrate 1 is covered entirely with the cover layer 2 is provided in this embodiment, another possible embodiment is that the cavity surface and a surface of the substrate 1 are partly brought into contact and the cover layer 2 is formed on the remaining part only.

In the first step, the substrate 1 may be placed in the cavity V either by inserting a substrate produced beforehand to between the cavity retainer plate 21 and the core retainer plate 31 or by producing a substrate in a mold by a conventional method to be used for producing a multilayer molded article, such as a core back method, a core rotation method, a stopper plate method, a core slide method, and a cavity slide method.

The thermoplastic resin material in a molten state supplied from the injection unit is injected through a gate 28a of the gate portion 28 and is filled into the clearance C (a second step). The injection rate of the thermoplastic resin material is 200 cm³/sec or more, and preferably 300 cm³/sec or more. Adjusting the injection rate to 200 cm³/sec or more makes it possible to highly reduce the viscosity of the resin material and fully spread the resin material in a molten state throughout the clearance C. Thereby, it is possible to form a cover layer with an excellent surface appearance widely on the substrate. On the other hand, if the injection rate is less than 200 cm³/sec, the viscosity of the thermoplastic resin material decreases insufficiently, so that an appearance defect of the cover layer 2 occurs easily. Generally, if a thermoplastic resin material to be injected contains a filler, a weld line is easily formed in the surface of a molded article. It, however, is possible to inhibit the formation of a weld line sufficiently by increasing the injection rate and reducing the thickness of the cover layer 2.

While the increase in the injection rate results in the above-mentioned advantage, it may also cause increase in the pressure in the cavity V, which may result in an insufficient efficiency of filling the resin material. Therefore, the clamping force of a mold is determined in the second step so that the mold halves may be pushed by the pressure in the cavity V to move relatively and thus the cavity volume can increase. Such determination of the clamping force makes it possible to prevent the pressure in the cavity V from increasing excessively and to transfer the shape of the cavity surface to the cover layer well. As a result, it becomes possible to prevent the occurrence of unevenness in gloss and to prevent a molded article to be obtained from having deteriorated appearance quality. The clamping force to be set may be determined appropriately according to the kind of the resin material to be used and the specification of the mold to be used.

The use of mold halves having cavity surfaces (surfaces 21a, 31a) which spread in the direction (Y-axis direction) vertical to the movement direction (X-axial direction) of the bottom clamping plate 30 as depicted in FIG. 4 allows the pressure in the cavity V to decrease sufficiently when the bottom clamping plate 30 moves slightly. In this embodiment, it is possible to produce a multilayer molded article 10 with a high dimension accuracy because it is possible to prevent the pressure in the cavity V from increasing excessively by moving the bottom clamping plate 30 about 0.1 mm in a direction that the cavity volume increases. The distance traveled by the bottom clamping plate can be measured by using a monitor that displays the position of a movable plate (not shown) mounted to an injection molding machine.

The method according to this embodiment has the advantage that it is possible to make the flow distance of a resin material longer in comparison to the conventional methods because it is possible to make the second thermoplastic resin material flow smoothly and to fill it into a cavity efficiently. From the viewpoint of using the advantage effectively, it is preferable to make the distance from a gate 28a to the flow end portion fed through the gate 28a (point P1 shown in FIG. 4) be 100 mm or more, more preferably 150 mm or more, even more preferably 200 mm or more, and still more preferably 300 mm or more. By making the distance be 100 mm or more, it is possible to render the number of gates to be provided to a mold comparatively small even when producing a large multilayer molded article, and it becomes possible to reduce appearance defects, such as welding in the surface of a multilayer molded article. Moreover, by making the distance be 150 mm or more (more preferably, 200 mm or more), it becomes easier to produce a large multilayer molded article efficiently.

Although the temperature of the cavity surface in the second step is determined appropriately according to the thermoplastic resin to be used, it is preferably 80° C. or more, and more preferably 90° C. or more. On the other hand, the temperature is preferably a temperature not higher than the crystallization temperature of the second thermoplastic resin material, and more preferably a temperature at least 10° C. higher than the crystallization temperature. If the temperature of the cavity surface is made 80° C. or higher, it is possible to secure the fluidity of a molten resin better in comparison to cases of being lower than 80° C. On the other hand, if the temperature of the cavity surface is made equal to or lower than the crystallization temperature of the resin, it is possible to make the time necessary for cooling shorter in comparison to cases of exceeding the crystallization temperature. The crystallization temperature of a thermoplastic resin material can be measured in accordance with JIS K7122 by using a differential scanning calorimeter.

In this embodiment, it is preferable to further carry out a third step of increasing the clamping force of the mold 100 after the second step. By doing so and thereby adding a pressing force to the resin material in the cavity V, it is possible to prevent deterioration in appearance, such as surface distortion and unevenness in gloss and, as a result, to obtain a multilayer molded article better in appearance quality. Since this treatment is applied to a resin material of a sufficiently high temperature, it is desirable to carry out the third step immediately after the second step. A pressing force can be added to the resin material located in the cavity V by increasing the clamping force applied to the mold 100 and thereby forcing the bottom clamping plate 30 so that the cavity volume will decrease. Although the clamping force to be applied during the third step may be determined appropriately depending upon the size of a molded article to be produced, a clamping force greater than that applied during the second step is applied. The rate at which the bottom clamping plate is moved in the third step is preferably 10 mm/sec or more, and more preferably 50 mm/sec or more. Performing the third step makes it possible to increase the flow distance of the resin material for forming the cover layer 2 and reduce the thickness of the cover layer 2 to be formed. By forming the cover layer 2 in the cavity V and then adding a pressing force to a resulting molded article, it is possible to obtain a multilayer molded article 10 better in appearance quality.

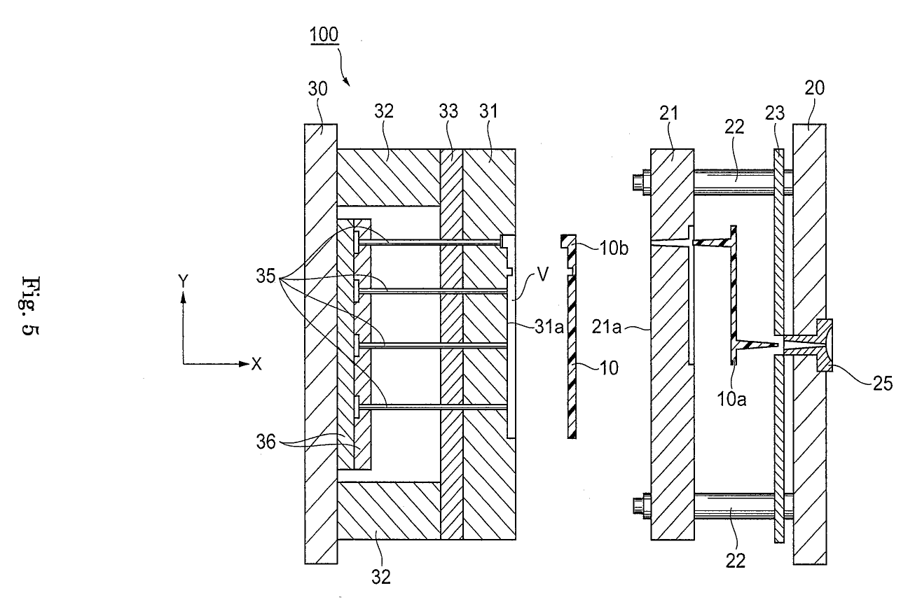

After the molded article is cooled for a cooling time of 1 to 60 seconds, the bottom clamping plate 30 is moved, and the cavity retainer plate 21 and the core retainer plate 31 are brought into an open state. The multilayer molded article 10 is removed from the core retainer plate 31 by using ejector pins 35 (see FIG. 5). Then, treatment of removing unnecessary portions 10a, 10b is applied, so that a multilayer molded article 10 as a product is completed.

The multilayer molded article 10 obtained by the method according to this embodiment is sufficiently excellent in both mechanical properties and surface appearance. Therefore, it can be used widely for automotive interior components or exterior components, motorcycle components, parts of furniture or electric appliances, building materials, and so forth, and it is particularly useful as an automotive exterior part. Moreover, it is possible to produce large-sized plastic parts with an excellent appearance quality efficiently by the method according to this embodiment.

A preferred embodiment of the present invention has been described in detail above, but the present invention is not limited to the embodiment. For example, a case that a multilayer molded article 10 having a shape illustrated in FIG. 1 has been provided in the above-described embodiment, but the shape of a multilayer molded article is not restricted thereto.

Moreover, although a case of using an apparatus having one sprue molding portion 27 and one gate portion 28 and injecting a resin material through one gate 28a into the cavity V has been provided in the above-described embodiment, the resin material may be injected through two or more gates. In this case, the distance from each gate to the flow end of the resin material fed through the gate is calculated on the basis of the quantity of the resin injected through the gate per unit time, the cross-sectional area of the clearance, and so on.

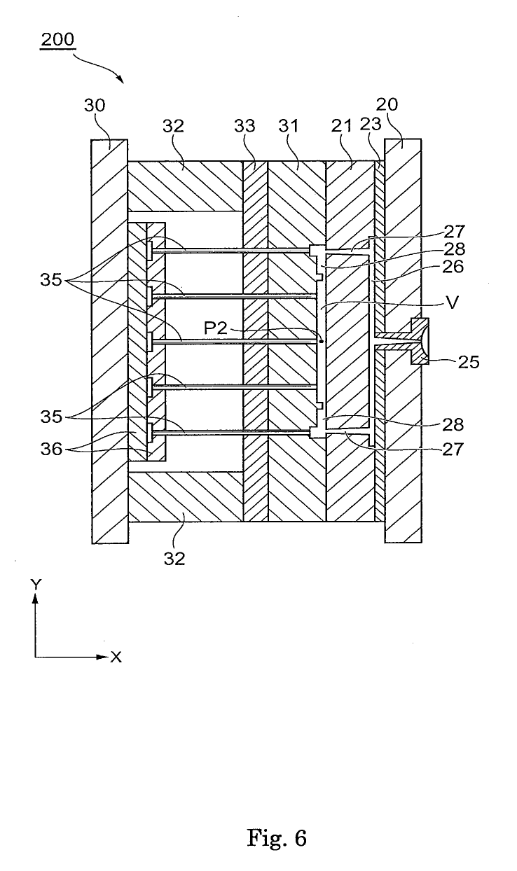

The mold 200 depicted in FIG. 6 has been configured to have two sprue molding portions 27 and two gate portions 28 and to be capable of injecting a resin material into the cavity V through two gates 28a simultaneously. The two gate portions 28 have been formed so that the cavity V may be situated therebetween in the Y-axis direction. The gate portions 28 and the runner molding portion 26 are interconnected through the respective corresponding sprue molding portions 27. When two gates 28a are provided at both ends of the cavity V, respectively, and a resin material is injected through the gates 28a at the same amount per unit time, the flow ends come to the center of the cavity V in the Y-axis direction (i.e., the point P2 shown in FIG. 6).

### EXAMPLES

### Example 1

A mixture of a crystalline polypropylene, talc and a rubber was used as a thermoplastic resin material for forming a cover layer. The compounding amounts are provided in Table 1. The crystallization temperature of the used mixture was 120° C., which was measured by DSC at a temperature decreasing rate of 10° C./min in accordance with JIS K7122. An apparatus having the same constitution as that of the apparatus illustrated in FIG. 2, i.e., having one gate in a cavity surface was used. A thermoplastic resin material was fed into the cavity through this gate, and a cover layer was formed so that it might cover entirely one side of a substrate (2.5 mm in thickness) made of a thermoplastic resin material. Thus, a multilayer molded article was produced. The formation of the cover layer was performed under the conditions provided in the column of Example 1 of Table 2. The cylinder temperature was 250° C. and the mold temperature was 100° C. On the cavity surface facing the substrate 1 was attached a 300 μm-thick polytetrafluoroethylene sheet. The heat conductivity of the polytetrafluoroethylene sheet used was 0.18 W/m·K. The mold closure rate applied in the third step was 70 mm/sec.

### Comparative Examples 1 and 2

Multilayer molded articles were produced in the same manner as in Example 1, except for changing the conditions with respect to the items shown in Comparative Examples 1 and 2 of Table 2 and forming respective cover layers.

### Evaluation Tests

As to the multilayer molded articles of Example 1 and Comparative Examples 1 and 2 produced as described above, the following evaluations were carried out. The results are shown in Table 2.

### (1) Flow Distance of a Resin Material for Forming a Cover Layer

As to a cover layer formed on a substrate layer, a flow distance was determined by measuring a distance from a gate for resin feed of a mold to a flow end.

### (2) Appearance Quality of a Multilayer Molded Article

(2-1) The surface of a multilayer molded article was observed visually, and the existence of unevenness in gloss was judged for a portion that had been located near the gate for resin feed.

(2-2) As to the whole body of a multilayer molded article, the existence of surface distortion was observed visually and whether the appearance quality was good or not was evaluated on the basis of the following criteria. In observation of a surface of a molded article under fluorescent light, if the image of the fluorescent light reflected on the surface looks distorted, it is determined that surface distortion has generated.

A: Generation of surface distortion was not detected.

B: Generation of surface distortion was detected.

TABLE 1

| Thermoplastic resin | Crystalline polypropylene | 60 parts by mass |
|---|---|---|
| Filler | Talc | 20 parts by mass |
| | Rubber | 20 parts by mass |

TABLE 2

| | | | Comparative | Comparative |
|---|---|---|---|---|
| | | Example 1 | Example 1 | Example 2 |
| First step | Clearance (mm) | 0.5 | 0.5 | 20 |
| Second step | Clamping | 0 | 1000 | 0 |
| force (kN) | | | | |
| | Injection rate | 230 | 97 | 314 |
| | (cm³/sec) | | | |
| | Filling time (sec) | 0.31 | 0.31 | 0.35 |
| Third step | Clamping | 1000 | 1000 | 1000 |
| | force (kN) | | | |

| | | | |
|---|---|---|---|
| Thickness of cover layer (mm) | 0.54 | 0.48 | 0.84 |
| Flow distance of cover | 205 | 141 | 208 |
| layer (mm) | | | |
| Gloss | Even | Even | Uneven |
| Appearance quality | A | B | A |

What is claimed is:

1. A method for producing a multilayer molded article comprising a substrate layer of a first thermoplastic resin material and a cover layer of a second thermoplastic resin material disposed on the substrate layer, the method comprising a first step of placing a substrate in a cavity formed between a pair of mold halves, and a second step of supplying the second thermoplastic resin material being in a molten state, at an injection rate of 200 cm³/sec or more to a space formed between the substrate and a cavity surface of a mold half facing the substrate, wherein in the second step, the clamping force of the pair of mold halves is set so that the cavity volume will increase due to pressure increase in the cavity accompanying the supply of the second thermoplastic resin material.

2. The method for producing a multilayer molded article according to claim 1, wherein the distance from a gate through which the second thermoplastic resin material in a molten state is supplied into the cavity to a flow end of the second thermoplastic resin material supplied through the gate is 150 mm or more.

3. The method for producing a multilayer molded article according to claim 1, wherein the thickness of the cover layer is 0.6 mm or less.

4. The method for producing a multilayer molded article according to claim 1, wherein the method further comprises a third step of increasing the clamping force of the pair of mold halves after the second step.

5. The method for producing a multilayer molded article according to claim 1, wherein the cavity surface is formed of a material having a heat conductivity of 0.05 to 10 W/m·K.

6. The method for producing a multilayer molded article according to claim 1, wherein in the second step the temperature of the cavity surface is 80° C. or higher and is not higher than the crystallization temperature of the second thermoplastic resin material.

7. The method for producing a multilayer molded article according to claim 1, wherein at least one of the first and second thermoplastic resin materials contains a crystalline polyolefin-based resin.

8. The method for producing a multilayer molded article according to claim 2, wherein the thickness of the cover layer is 0.6 mm or less.

9. The method for producing a multilayer molded article according to claim 2, wherein the method further comprises a third step of increasing the clamping force of the pair of mold halves after the second step.

10. The method for producing a multilayer molded article according to claim 2, wherein in the second step the temperature of the cavity surface is 80° C. or higher and is not higher than the crystallization temperature of the second thermoplastic resin material.
